(19) United States
(12) Patent Application Publication
(10) Pub. No.: US 2026/0132919 A1
(43) Pub. Date: May 14, 2026

(54) Lighting Element for a Power Tool

(71) Applicant: Robert Bosch GmbH, Stuttgart (DE)

(72) Inventors: Jeremy Rubens, Palatine, IL (US); Alexander Hills, Belvidere, IL (US)

(21) Appl. No.: 19/359,936

(22) Filed: Oct. 16, 2025

Related U.S. Application Data
(60) Provisional application No. 63/714,375, filed on Oct. 31, 2024.

(51) Int. Cl. F21V 33/00; F21L 4/02; F21V 3/04; F21Y 103/10; F21Y 103/33; F21Y 115/10

(52) U.S. Cl. CPC F21V 33/0084; F21L 4/02; F21V 3/04; F21Y 2103/10; F21Y 2103/33; F21Y 2115/10

(57) ABSTRACT

A power tool includes a tool housing, an outer surface of which supports a portion of an elongate LED filament. The LED filament includes a flexible substrate and micro-LEDs disposed on the substrate in an electrically connected arrangement in such a way the light is emitted from the LED filament in a direction perpendicular to the substrate over a range of angles from 0 degrees to 360 degrees. The relatively small diameter and large flexibility of the LED filament and the intense illumination provided by the LED filament make the LED filament suited for use as an illumination device in small devices such as hand-held power tools.

### BACKGROUND

It has become popular to use lighting elements such as those including Light emitting diodes (LEDs) to provide accent lights and ring lights in some cars and relatively large high-end products. However, it can be more challenging to use lighting elements including LEDs in smaller devices where available packaging space is limited. For example, using LEDs to provide accent lighting or workpiece illumination in a hand-held power tool may be challenging since the LEDs may require mounting on a printed circuit board and/or routing of a power supply (or the lighting components themselves) through the product. On the other hand, it is desirable to provide improved workpiece illumination and/or accent lighting in a hand-held power tool without having to enlarge the tool housing or power supply.

### SUMMARY

An LED filament lighting component may be employed to highlight or accent tool features and to more effectively illuminate a workpiece during tool operation including cutting, sanding, buffing, etching, etcetera. The LED filament may be used for aesthetic and/or light distribution purposes and does so with the high efficiency of conventional light-emitting diodes (LEDs). The LED filament is an elongate, thin illuminating element that is sufficiently flexible to bend in sharp turns with respect to multiple axes and in complicated shapes. This can be compared to some conventional LED strips which, due to the width of the thin substrate that supports the LEDs, are flexible about a single axis, e.g., the axis that extends in the width direction of the substrate.

Further advantageously, the filament includes micro-LEDs. Micro-LED (also known as mLED or μLED) is a display technology that is based on tiny LED devices that may be used, for example, to directly create color pixels. In an LED filament, the mLEDs are compactly and serially arranged to provide a light intensity that is greater than some conventional LED strips and emit light over a greater range of angles as compared to some conventional LED strips. As used herein the term “micro-LED” refers to an LED having dimensions of a few microns while the term “filament” refers to a substrate that is elongate, thin and substantially equally flexible in three dimensions in the manner of a thread or string. Due to its slim structure, the relatively high light intensity and the multi-axis bendability, the LED filament can be configured and positioned to place the lighting component where it needs to be, which may be different for each type of tool depending on the tool attributes and requirements.

In some embodiments, the LED filament may be routed around housing features along an outer surface of the tool housing to create cosmetic detail features or to provide accent lighting of tool housing details. In other embodiments, the LED filament may be strategically routed along an outer surface of the tool housing to provide workpiece illumination. In still other embodiments, the LED filament may be disposed inside the tool housing and arranged to cooperate with transparent portions of the tool housing to provide accent light of tool housing details and/or workpiece illumination. The accent lighting may be white or a different color and the color of the accent lighting depends on the properties of the specific LED filament used. The LED filament is a low-voltage, low current device that can be powered by the tool power supply or a separate power supply. As used herein the term “low voltage” refers to voltages of less than 5 volts, and the term “low current” refers to currents less than 200 mA.

In some embodiments, the LED filament may be arranged in a coil, for example circling the nose piece of a rotary power tool. By providing a coil of multiple turns, the combined effect of the coils is a brighter, more intense light than obtained by a single LED filament. This effect provides a spotlight or flashlight effect when encircling the power tool nose piece.

In some embodiments, the LED filament may be routed around components of the tool that, when in use, are closely adjacent to the workpiece. For example, when surrounding a periphery of the sanding pad of a sander, illumination is broadcast on the workpiece from a location close to the surface of the workpiece. The light broadcast close to the surface, in combination with the ability of the LED filament to emit light across a 360 degree range, enables the user to clearly see the texture of the surface, inspect the surface finish and determine whether the surface has been adequately sanded.

In some embodiments, the LED filament may be routed around the cutting blade to illuminate the cutting area on a workpiece and reduce or eliminate shadow formation. For example, the filament may be placed on a foot of a jigsaw power tool. More specifically, the filament may extend along the cutout of the foot that receives the jigsaw blade. The light broadcast close to the workpiece and surrounding the cutting blade, in combination with the ability of the LED filament to emit light across a 360 degree range, minimizes or eliminates shadows on the workpiece surface. This can be compared to some conventional tool lighting configurations in which a light source on the tool housing (e.g., from above the blade), which can result in the cutting blade and tool footplate casting shadows on the surface of the workpiece that make it difficult to see the cutting path.

In some embodiments, the LED filament is received in a groove formed on an outer surface of the tool housing. The groove is shaped and dimensioned to receive the LED filament and to retain the LED filament within the groove. The groove may have a depth dimension that is less than a diameter of the LED filament, whereby the LED filament protrude from the groove. In other embodiments, the groove may have a depth dimension that is greater than a diameter of the LED filament, whereby the LED filament is recessed relative to the tool housing. The groove may extend into the tool housing in a direction perpendicular to the tool housing surface or may extend into the tool housing in a direction that is acutely angled relative to the tool housing surface. In some embodiments, the angle of the groove is selected so that light is emitted in a predetermined direction.

In some aspects, a power tool includes a tool housing and an electric motor disposed in the tool housing. The electric motor has an output shaft. The power tool includes a working tool that is mechanically connected to the output shaft and protrudes from the tool housing. The working tool is configured to transmit the motion of the output shaft to an accessory of the tool. In addition, the power tool includes an elongate LED filament. A portion of the LED filament is supported on a portion of the tool housing. The LED filament includes a substrate and micro-LEDs disposed on the substrate in a spaced-apart, electrically connected arrangement in such a way the light is emitted from the LED filament in a direction perpendicular to the substrate over a range of angles from 0 degrees to 360 degrees.

In some embodiments, the substrate has sufficient flexibility that the LED filament can bend about each of three orthogonal axes through a radius of 5 mm.

In some embodiments, the portion of the tool housing includes a portion of an outer surface of the tool housing having a contoured shape, and the portion of the LED filament is arranged on the portion of the tool housing in such a way as to illuminate the contoured shape.

In some embodiments, the portion of the tool housing includes a portion of an outer surface of the tool housing having a contoured shape, and the portion of the LED filament is arranged on the portion of the tool housing in such a way as to trace a profile of the contoured shape.

In some embodiments, the portion of the tool housing includes a groove and the groove is configured to receive and retain the portion of the LED filament. In addition, the portion of the LED filament is disposed in the groove.

In some embodiments, the groove is formed on an outer surface of the tool housing. The groove is shaped and dimensioned so that when the portion of the LED filament is disposed in the groove, the portion of the LED filament protrudes relative to the tool housing outer surface.

In some embodiments, the groove is formed on an outer surface of the tool housing. The groove is shaped and dimensioned so that when the portion of the LED filament is disposed in the groove, the portion of the LED filament is recessed relative to the tool housing outer surface.

In some embodiments, when the groove is viewed in cross-section, a groove axis is defined by a line extends through a first point and a second point, where the first point is midway between sidewalls of the groove at a location corresponding to the intersection of the groove with the tool housing outer surface and the second point is midway between sidewalls of the groove at a location corresponding to a blind end of the groove. The groove axis is perpendicular to the portion of the tool housing.

In some embodiments, when the groove is viewed in cross-section, a groove axis is defined by a line extends through a first point and a second point, where the first point is disposed midway between sidewalls of the groove at a location corresponding to the intersection of the groove with the tool housing outer surface and the second point is disposed midway between sidewalls of the groove at a location corresponding to a blind end of the groove. The groove axis is acutely angled with respect to the portion of the tool housing.

In some embodiments, the LED filament includes an elongate, cylindrical body having a first end and a second end that is opposite the first end, a first electrical terminal protruding from the first end, and a second electrical terminal protruding from the second end. The body has a diameter in a range of 1 mm to 5 mm.

In some embodiments, the LED filament includes an elongate body having a first end and a second end that is opposite the first end. The body has a length corresponding to a distance between the first end and the second end when the body is arranged linearly. In addition, the body supports at least 300 micro-LEDs per meter of body length.

In some embodiments, the LED filament includes a flexible cylindrical substrate that supports micro-LEDs along a length of the substrate, and wherein the substrate is covered by a coating that extends along the length of the substrate and about the circumference of the substrate such that the coating is concentric with the substrate and encloses the substrate and the micro-LEDs.

In some embodiments, the power tool is configured to connect to a power supply, and the power supply powers the electric motor and the LED filament.

In some embodiments, the power tool includes a structure that abuts a surface of the workpiece when the power tool is in use. The structure has a contact surface that faces and abuts the workpiece when the power tool is in use and an adjoining surface that adjoins the contact surface along an edge. The portion of the tool housing extends along the edge whereby the portion of the LED filament extends along the edge.

In some embodiments, the portion of the LED filament is arranged in a coil stack.

In some embodiments, the portion of the outer surface of the tool housing encircles a circumference of the tool housing, and the portion of the LED filament encircles the portion of the outer surface of the tool housing at least twice.

### BRIEF DESCRIPTION OF THE FIGURES

FIG. 1 is a side view of a battery-operated hand power tool 1 realized as an eccentric sander.

FIG. 2 is a side cross-sectional view of the sander of FIG. 1.

FIG. 3 is a schematic representation of the LED filament.

FIG. 4 is a cross-sectional view of the LED filament as seen along line 4-4 of FIG. 3.

FIG. 5 is an enlarged side view of the LED filament.

FIG. 6 is an example of an arrangement of traces and micro-LEDs as provided in the LED filament.

FIG. 7 is a side view of a portion of the sander of FIG. 1, illustrating the LED filament supported on the working tool of the sander.

FIG. 8 is a perspective view of the working tool of FIG. 7 isolated from the sander, illustrating the groove and omitting the LED filament.

FIG. 9 is a perspective view of the working tool of FIG. 7 isolated from the sander, illustrating the groove and showing the LED filament disposed in the groove.

FIG. 10 is a schematic cross-sectional view of a portion of the tool housing illustrating a first configuration of the groove.

FIG. 11 is a schematic cross-sectional view of a portion of the tool housing illustrating a second configuration of the groove.

FIG. 12 is a schematic cross-sectional view of a portion of the tool housing illustrating a third configuration of the groove.

FIG. 13 is a perspective view of the working tool of FIG. 7, illustrating a groove configured to direct light downward toward the workpiece, FIG. 13 including an insert figure that illustrates a schematic cross-sectional view of a portion of the tool housing showing that the groove of FIG. 13 is acutely angled.

FIG. 14 is a schematic representation of an LED filament showing many small closely spaced micro-LEDs supported along a filament, and how the illumination from the LED filament provides high resolution shadows of an object.

FIG. 15 is a schematic representation of a prior art LED strip showing relatively fewer conventional LEDs that have a relatively greater spacing and are supported on a relatively wide substrate as compared to an LED filament, and how the illumination from the conventional LED strip provides fewer and coarser shadows of an object as compared to an LED filament.

FIG. 16 is an exemplary illustration of an LED filament being employed on a rotary tool 100 to accentuate features of the tool housing.

FIG. 17 is another exemplary illustration of an LED filament being employed on a rotary tool 100 to accentuate features of the tool housing.

FIGS. 18 and 19 is an exemplary illustration of coiled LED filaments being employed on a rotary tool to provide accentuation and illumination. FIG. 18 is an exploded view of a rotary tool and a nosepiece accessory. FIG. 19 is a perspective view of the rotary tool of FIG. 18.

FIG. 20 illustrates an LED filament being employed on the housing of a jigsaw, showing the LED filament tracing the profile of a cutout of the foot plate of the housing.

FIG. 21 illustrates LED filaments being employed on the housing of a jigsaw, showing a one LED filament tracing the profile of a cutout of the foot plate of the housing and another LED filament surrounding a portion of the motor housing region of the tool housing.

### DETAILED DESCRIPTION

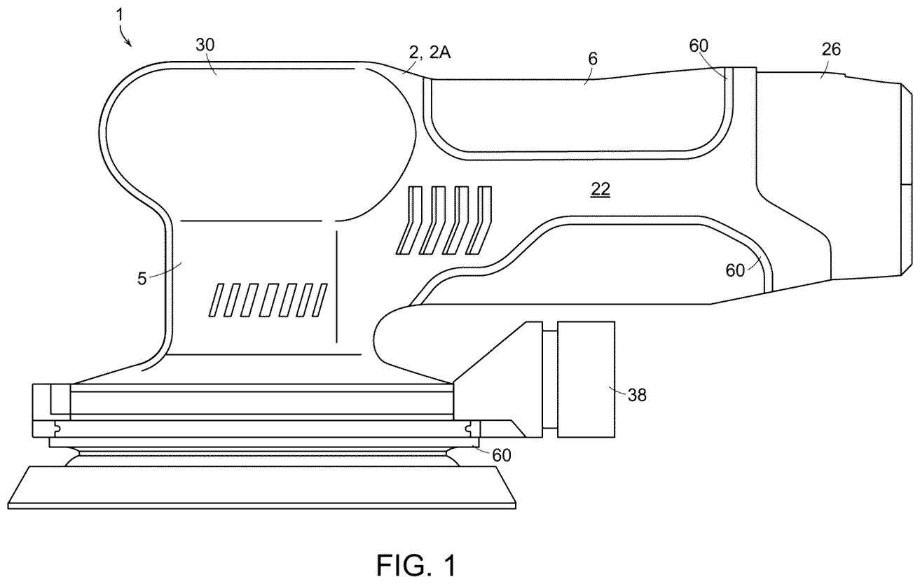

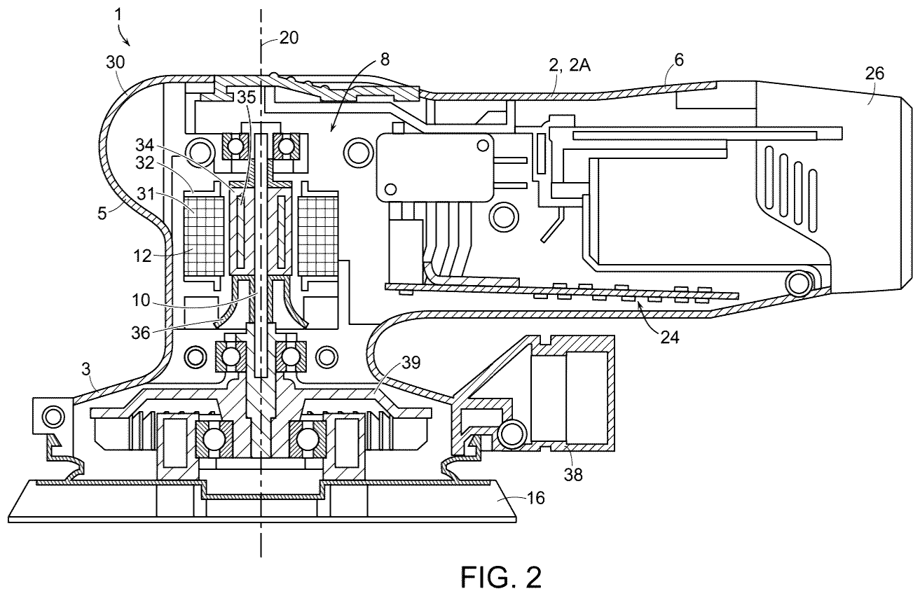

Referring to FIGS. 1 and 2, a hand-held, battery-operated power tool 1, realized as an eccentric sander, includes a tool housing 2. The tool housing 2 is composed of at least one first housing half-shell 2A and one second housing half-shell (not shown). When assembled together, the first and second housing half shells provide a hollow closed structure that receives and supports the tool drive components, which are briefly described below. The sander 1 includes an LED filament 60 that is supported on an outer surface of the tool housing 2. The LED filament 60 may be used to accentuate elements of the tool housing 2 such as contours, overmolded regions, or design features. In addition, or alternatively, the LED filament 60 may be used in strategic locations to provide enhanced illumination. In some embodiments, such placement of the LED filament 60 serves to highlight workpiece surface textures, permitting the user to achieve an improved outcome as compared to some previous illumination arrangements and system. Details of the power tool 1 and the LED filament 60 are provided below along with some exemplary applications of the LED filament as a lighting element of the power tool 1.

The tool housing 2 includes a motor housing region 5 and a handle region 6. An electric motor drive 8 is disposed in the motor housing region 5. The electric motor drive 8 is connected to an output shaft 10. In the illustrated embodiment, the electric motor drive 8 is an electronically commutated electric motor 12. The motor 12 and the output shaft 10 constitute a common first axis 14. The first axis 14 is coaxial with the output shaft 10. Via an eccentrically disposed bearing, the output shaft 10 is connected to a carrier shaft, which carries a working tool 16. In the illustrated embodiment, the working tool 16 of the battery-operated hand power tool 1 is a backing pad, to the underside of which an abrasive device such as sand paper or a sanding block can be attached for working the surface of a workpiece. The bearing may be a ball bearing, and enables the carrier shaft to autorotate about a carrier rotation axis, which at the same time constitutes the rotation axis of the working tool 16. The rotation axis of the carrier shaft is parallel to the rotation axis 14 of the output shaft 10 and is eccentrically spaced apart therefrom.

The handle region 6 provides a handle 22 that is used by an operator to manually grip the power tool 1. The term “handle” refers to a component around which at least one hand of the operator may be placed for the purpose of guiding the power tool 1. The motor housing region 5 and the handle region 6 may be disposed at an angle to each other. In the illustrated embodiment, the motor housing region 5 and the handle region 6 are at an angle of approximately 90°in relation to each other.

A set of electronics 24 is disposed in the handle region 6. The set of electronics 24 is provided to energize the motor 12. Although the set of electronics 24 is disposed in the handle region 6, it is also conceivable for the set of electronics 24 to be, for example, integrated in the motor 12 or realized separately.

A rechargeable battery 26 serves as an energy source for the electric motor drive 8 and for the LED filament 60.

In the illustrated embodiment, the handle region 6 has a first grip region 28 that defines a region around which the hand of the operator is laid when guiding power tool 1. In order to achieve particularly convenient guiding of the power tool 1, it is advantageous to dispose a second grip region 30 on the motor housing region 5. The second grip region 30 may be shaped as a knob, which also gives a pleasing visual appearance. The second grip region 30 is designed in such a manner that it lies in the operator's hand in a particularly ergonomic manner.

The motor 12 drives the carrier shaft directly. The term “directly” refers to the electronically commutated electric motor 12 being connected to the carrier shaft without the interposition of a conventional gearing such as, for example a planetary gearing, bevel gearing or spur gearing. The eccentrically disposed working tool 16 of the power tool 1 executes a swinging motion. In this case, the travel that is produced during the swinging motion is twice as great as the eccentric distance between the rotation axis of the carrier shaft and the first axis 14.

The electronically commutated electric motor 12 includes a stator 32 which carries the current-carrying windings 31. The stator 32 is located on the motor housing. A rotor 34, which carries permanent magnets 35, is connected to the output shaft 10.

Since in the case of hand power tools 1 having electronically commutated electric motors 12, the set of electronics 24 is designed so as to be more powerful and with a greater size and volume than in the case of brush motors, cooling becomes increasingly important, with the resultant need for optimum cooling. The cooling may be realized as passive or active cooling. In the case of passive cooling, the thermal energy is removed by convection. In the case of active cooling, the thermal energy of the components to be cooled is removed with the aid of a cooling system. In the illustrated embodiment, the cooling system is a fan 36. The fan 36 for cooling the electric motor drive 8 is integrated in the first motor housing region 5. In particular, the fan 36 is disposed between the electronically commutated electric motor 12 and the working tool 16. It is also conceivable, however, for other cooling systems to be used, such as Peltier elements, closed cooling circuits or the like. It is equally conceivable to dispense with the fan, and to realize the cooling, for example, by means of strategically disposed cooling ribs and/or cooling bodies.

The power tool 1 includes a dust suction device 38 attached to the tool housing 2. The working tool 16 has drilled holes, distributed over its circumference, via which sanding dust produced during the working of the workpiece is sucked into the motor housing by means of a dust fan 39, the dust fan 39 being fixedly connected to the output shaft 10. The sanding dust transported through the drilled holes of the working tool 16 is routed, via the dust suction device 38, into a dust collecting container, not shown.

A switching element is provided for switching on the battery-operated hand power tool 1. The switching element may be realized, for example, as a biased-off switch. It is also conceivable, however, for the switching element to be realized as a continuous speed-control switch or as an arresting switch.

In the exemplary embodiment, the power tool 1 is realized as a battery-operated hand sander 1. As can be seen in FIGS. 1 and 2, the rechargeable battery 26 is connected to a rear side of the tool housing 2. A battery voltage indicator may be integrated in the handle region. The battery voltage indicator may be provided to provide a visual indication of the level of the battery voltage. This may be achieved by means of a colored LED, a blinking LED, digital indicator elements, LCD and the like.

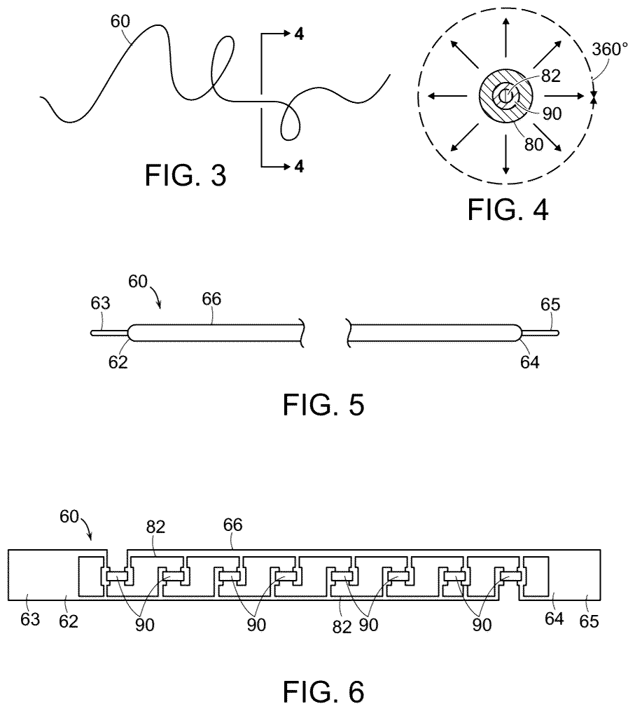

Referring to FIGS. 3-6, the LED filament 60 includes an elongate, cylindrical body 66 having a first end 62 and a second end 64 that is opposite the first end 62. The LED filament 60 includes a first electrical terminal 63 protruding from the first end 62 and includes a second electrical terminal 65 protruding from the second end 64. The body 66 is slender, for example having a diameter in a range of 1 mm to 5 mm.

The body 66 of the LED filament 60 may be made of a thin, flexible material such as plastic or silicone. This allows the LED filament 60 to be bent and shaped to fit into various lighting fixtures and designs. The material used for the LED filament 60 is also chosen for its ability to withstand heat and provide electrical insulation for the electrical components within.

The LED filament 60 includes an array of electrically connected micro-LEDs 90. The micro-LEDs 90 used in the LED filament 60 are extremely small, typically measuring only a few micrometers in size. The micro-LEDs 90 may be made of semiconductor materials such as gallium nitride (GaN) or indium gallium nitride (InGaN), which are known for their high efficiency and long lifespan. However, any appropriate materials may be used to form the micro-LEDs 90.

The micro-LEDs 90 are electrically connected in series along the flexible LED filament 60, allowing for a continuous flow of electricity to power the entire length of the LED filament 60. The series connection ensures that all the micro-LEDs 90 receive the same amount of electrical current, resulting in a consistent, continuous and uniform light output. The electrical connections are typically made using thin, conductive traces 82 that are integrated into the flexible material of the LED filament 60. In some embodiments, the traces 82 serve as a substrate, and the flexible material is applied as a coating 80 to the traces 82. For example, the coating 80 may extend along the length of the substrate and about the circumference of the substrate such that the coating 80 is concentric with the substrate and encloses the substrate and the micro-LEDs 90.

One end of the trace 82 corresponds to the first electrical terminal 63 protruding from the first end 62, while the opposed end of the trace 82 corresponds to the second electrical terminal 65 protruding from the second end 64. The first and second electrical terminals 63, 65 are electrically connected to a power circuit that includes the motor 12, the battery 26, the control electronics 24, and one or more power switches (not shown).

The traces 82 are designed to be flexible and durable. Together with the flexible coating 80, the traces 82 permit the LED filament 60 to be bent and shaped without compromising the electrical connections. For example, in some embodiments, the traces 82 have sufficient flexibility that the LED filament 60 can bend about each of three orthogonal axes through a radius of 15 mm. In other embodiments, the LED filament 60 can bend about each of three orthogonal axes through a radius of 5 mm or less. This permits the LED filament 60 to be arranged in fanciful, irregular curvilinear configurations (FIG. 3), to closely follow sharp changes in surface shape including bending around corners, or to be arranged in a coiled stack to multiply the illuminating effects of the micro-LEDs 90.

In the LED filament 60, light is directed outward from the traces 82 in a direction perpendicular to the traces 82 over a 360 degree range (FIG. 4). In the illustrated embodiment, the LED filament 60 supports at least 300 micro-LEDs per meter of filament length. In some embodiments, the body supports at least 500 micro-LEDs per meter of filament length. As used herein, the term “filament length” refers to a distance between the filament first end 62 and the filament second end 64 when the LED filament 60 is arranged linearly.

A benefit of the filament design is potentially higher efficiency due to the use of more LED emitters with lower driving currents. Another benefit of the design is the ease with which near full “global” (360°) illumination can be obtained from arrays of micro-LEDs 90.

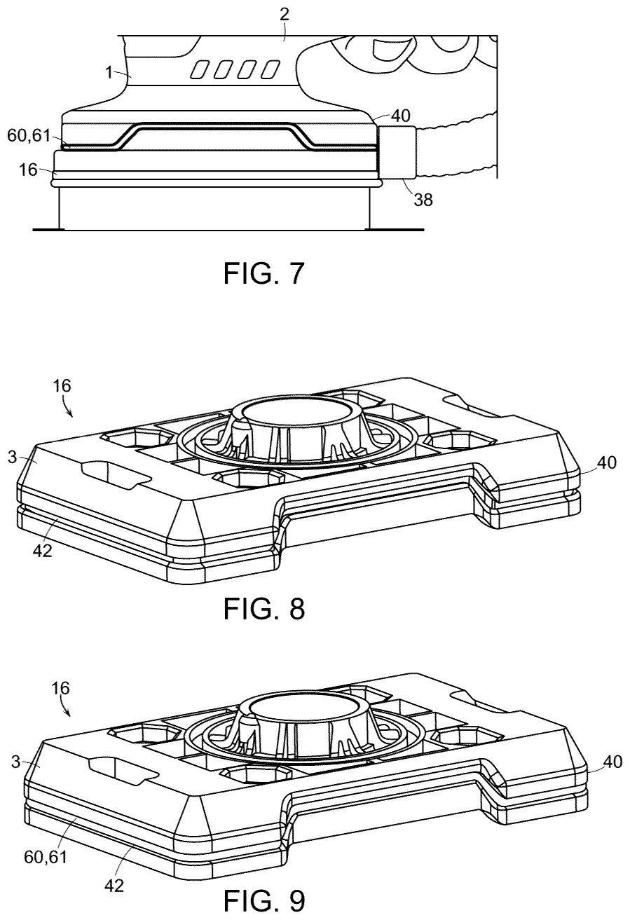

Referring to FIGS. 7-9, the LED filament 60 may be employed on the power tool 1 to highlight or accent tool features and/or tool housing features and to more effectively illuminate a workpiece during tool operation than some conventional power tools. The LED filament 60, or a portion 61 thereof, may be supported on a portion 40 of the tool housing 2.

In some embodiments, the portion 40 of the tool housing 2 includes a portion of an outer surface 3 of the tool housing 2 having a contoured shape, and the portion 61 of the LED filament 60 is arranged on the portion 40 of the tool housing 2 in such a way as to illuminate the contoured shape. For example, the LED filament portion 61 may follow the contours (e.g., the LED filament may trace a profile of the contoured shape) in order to highlight the contours.

The LED filament 60 may be fixed to the tool housing, for example using adhesives, clips or other appropriate techniques. In the illustrated embodiment, for example, the tool housing outer surface 3 includes a shallow groove 42 that is configured to receive and retain the portion 61 of the LED filament 60 therein via a press fit.

In some embodiments, the groove is shaped and dimensioned so that when the portion 61 of the LED filament 60 is disposed in the groove 42, the portion 61 of the LED filament 60 protrudes relative to tool housing outer surface 3. This can be accomplished in one example by having a depth of the groove 42 be less than a diameter of the LED filament 60.

In some embodiments, the groove 42 shaped and dimensioned so that when the portion 61 of the LED filament 60 is disposed in the groove 42, the portion 61 of the LED filament 60 is recessed relative to the tool housing outer surface 3. This can be accomplished for example by having a depth of the groove 42 be greater than a diameter of the LED filament 60.

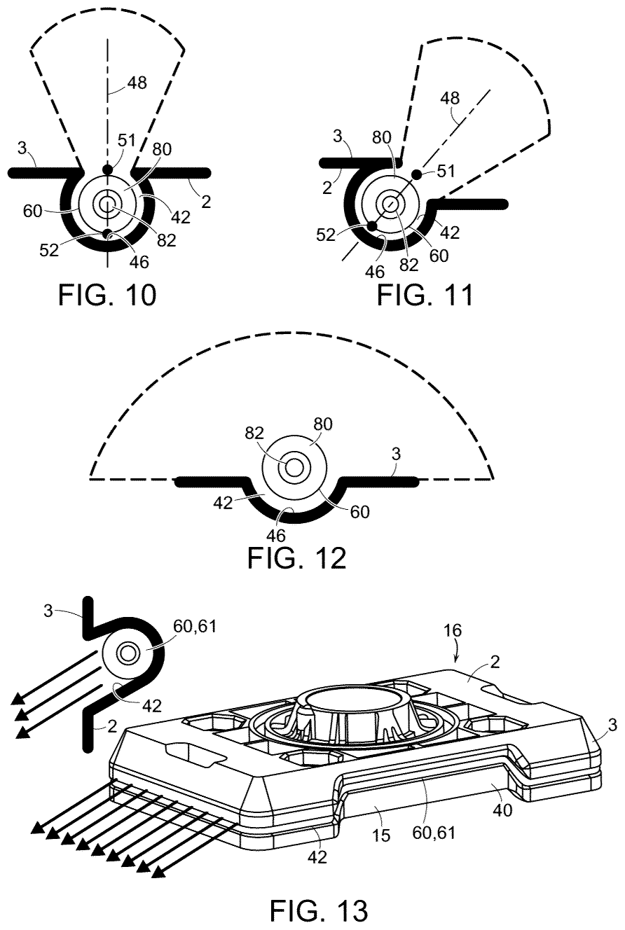

Referring to FIGS. 10-13, the depth of the groove 42 and/or the geometry of the groove 42 can be configured to direct light where desired including toward a tool housing feature to be highlighted or toward the workpiece. When the groove 42 is viewed in cross-section, a groove axis 48 is defined by a line that extends through a first point 51 and a second point 52, where the first point 51 is midway between sidewalls 44 of the groove 42 at a location corresponding to the intersection of the groove 42 with the tool housing outer surface 3 and the second point 52 is midway between sidewalls 44 of the groove 42 at a location corresponding to a blind end 46 of the groove 42. In the schematic illustration of the groove 42 shown in FIG. 10, the groove axis 48 is perpendicular to the tool housing outer surface 3. In addition, the LED filament 60 is recessed relative to the tool housing outer surface 3, whereby the light emitted from the groove 42 is generally directed in a direction perpendicular to the tool housing outer surface 3. An arc length of the emitted light is determined in part by a width of the groove 42 at the first point 51 (e.g., by a width of the groove opening).

Similarly, in the schematic illustration of the groove 42 shown in FIG. 11, the groove axis 48 is acutely angled relative to the tool housing outer surface 3 and the LED filament 60 is recessed relative to the tool housing outer surface 3. However, in this example, the light emitted by the LED filament 60 is directed generally directed at the acute angle relative to the tool housing outer surface 3.

In the schematic illustration of the groove 42 shown in FIG. 12, the groove 42 is relatively shallow whereby the LED filament 60 protrudes relative to the tool housing outer surface 3. In this embodiment, the LED filament 60 emits light in an arc of about 180 degrees.

Referring to FIG. 13, the groove 42 may be provided along a periphery of the sander working tool 16 at a location closely adjacent to the surface to which the abrasive device is attached. In this example, the LED filament 60 is recessed, and the groove 42 is configured so that the groove axis 48 is directed toward a workpiece surface. In this example, the groove 42 also highlights the contours of the working tool 16 since the groove 42, and thus also the LED filament 60, follows the contours into and out of the side recesses 15 of the working tool 16 and through different elevations relative to the work surface. This is possible since the LED filament 60 is flexible in multiple axes, permitting illumination along complex, multi-axis bends.

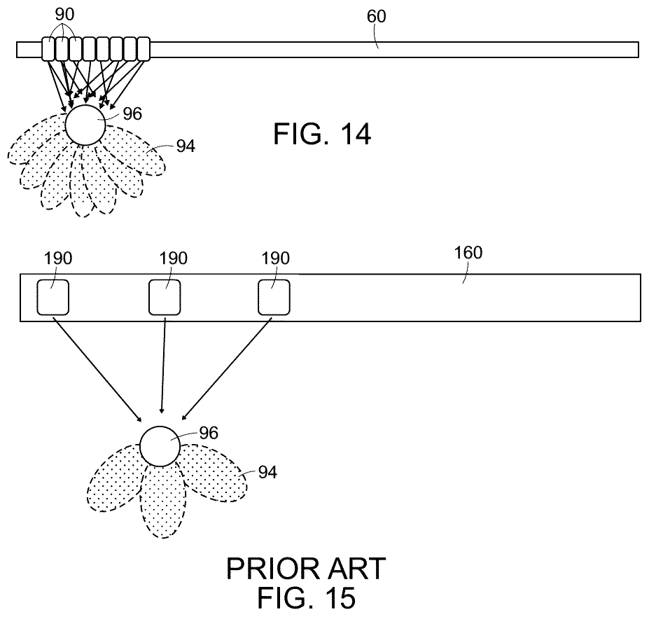

Referring to FIGS. 14 and 15, the relatively fine profile of the LED filament 60 advantageously permits the LED filament 60 to be placed very close to a surface of the workpiece (FIG. 14) as compared to some conventional LED lighting devices having a larger substrate and standard-sized LEDs (FIG. 15). In addition, the high density of micro-LEDs 90 on the LED filament 60 generates a nearly continuous line of light. This arrangement of the LED filament 60 may direct light generally horizontally, with the result that imperfections 96 in the workpiece surface create shadows. Due to the high density of the micro-LEDs 90, the resolution of the shadows 94 is increased relative to some conventional LED lighting devices 160 having a larger substrate 182 and standard-sized LEDs 190, providing additional detail regarding any imperfections in the workpiece surface.

In the embodiments illustrated in FIGS. 1-15, the battery-operated hand power tool 1 is a sander and the working tool 16 of the sander 1 is a backing pad, to the underside of which an abrasive device such as sand paper or a sanding block can be attached for working the surface of a workpiece. In other embodiments, for example when the battery-operated hand power tool 1 is a drill, a saw, a grinder, a rotary tool, an oscillating tool, etc., as discussed below, the working tool 16 may be a spindle in combination with a chuck, clamp or other attachment device for connecting a bit, blade, grinding tool, etc., to the spindle.

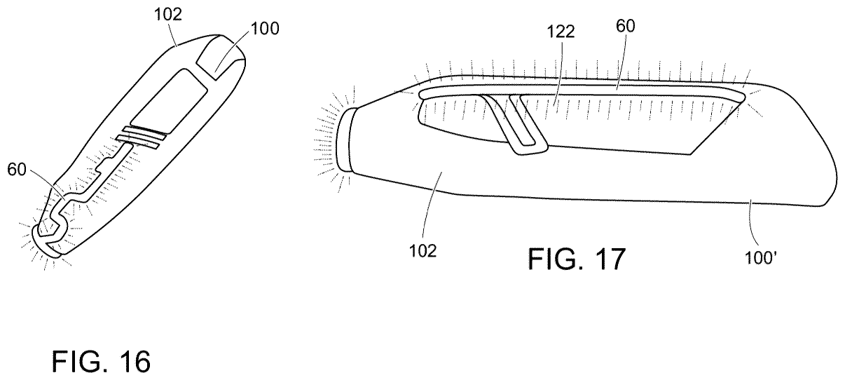

Referring to FIGS. 16-22, the power tool 1 is not limited to being a sander. The LED filament 60 may be employed with other types of hand-held power tools, including but not limited to drills, saws, grinders and rotary tools.

As seen in FIGS. 16 and 17, the LED filament 60 may be used with the housing 102 of a rotary cutting tool 100, 100′ to highlight details and or style features of the tool housing 102. In FIG. 16, the LED filament 60 is used in a rotary tool 100 to highlight the switches and/or human machine interfaces (HMI), while in FIG. 17 the LED filament 60 is used in a rotary tool 100′ to highlight the elongated shape of the handle 122.

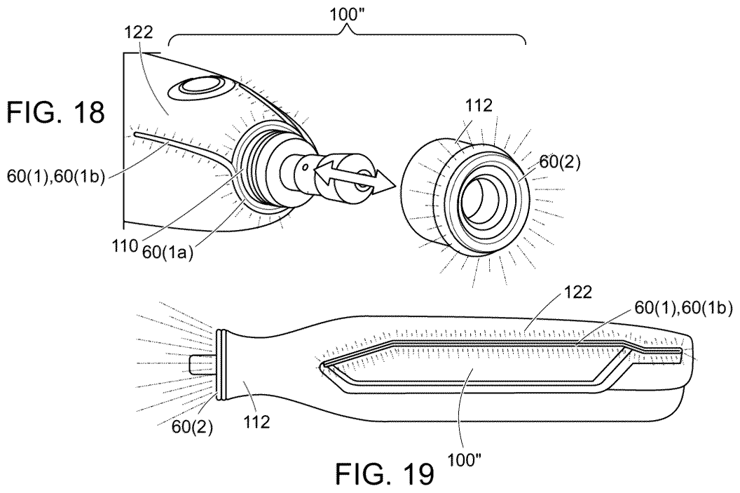

As seen in FIGS. 18 and 19, another rotary tool 100′ includes a first LED filament 60(1) that is coiled about a circumference of a front end 110 of the rotary tool 100″. The first LED filament 60(1) includes a first filament portion 60(1a) that is coiled about the circumference of the front of the rotary tool 100″ and thus provides general illumination at the front of the rotary tool 100″ and a second filament portion 60(1b) that extends rearward along the tool handle 122 in a way that accentuates the shape of the tool handle 122. In addition, a second LED filament 60(2) is coiled about a nose piece accessory 112. The nose piece accessory 112 can be mechanically connected to the tool front end 110. The second LED filament 60(2) can direct light toward the workpiece and the cutting accessory. In addition, by coiling the first filament portion 60(1) and the second LED filament 60(2), the intensity of the illumination is increased relative to light emitted by a linear arrangement of the second LED filament 60.

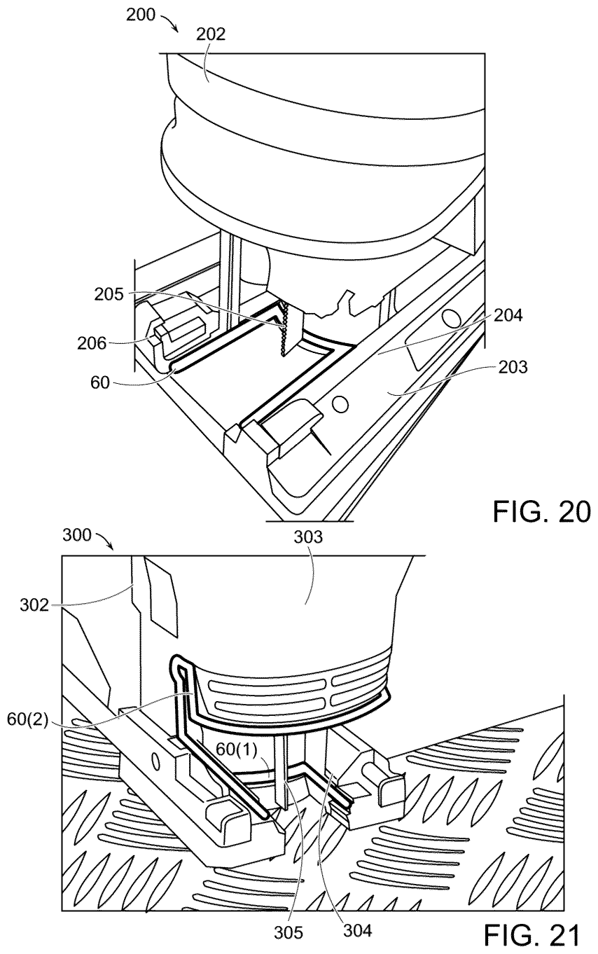

Referring to FIG. 20, the LED filament 60 may be employed with the housing 202 of a saw. In the illustrated embodiment, the saw is a jigsaw 200 in which the housing 202 includes a footplate 203 that rests on the workpiece when the jigsaw 200 is in use. The footplate 203 includes a cutout 204 that opens along a front edge 206 of the footplate 203. The jigsaw blade 205 extends through the cutout 204 in a direction perpendicular to the workpiece surface. The cutout 204 partially surrounds the blade 205 and a gap exists between the blade 205 and the cutout 204. The LED filament 60 is routed along the edge of the cutout 204 so as to extend from the footplate front edge 206 and partially surround the cutting blade 205. Since the light emitted from the LED filament 60 is broadcast close to the workpiece and surrounding the cutting blade, and since the LED filament 60 emits light across a 360 degree range, the illustrated configuration minimizes or eliminates shadows on the workpiece surface. This can be compared to some conventional tool lighting configurations in which a light source is provided at a location above the blade 205, which can result in the cutting blade and tool footplate casting shadows on the surface of the workpiece that make it difficult for a user to see the cutting path.

Referring to FIG. 21, the power tool 1 may include multiple LED filaments 60. In the illustrated embodiment, the jigsaw 300 includes a first LED filament 60(1) routed along the footplate cutout 304, and a second LED filament 60(2) routed along a front-facing portion of the motor housing region 303 of the tool housing 302. While the first LED filament 60(1) provides a clear view of the location of the blade 305 with respect to the workpiece, the second LED filament 60(2) provides general illumination of the area in front of the jigsaw 300.

Although the hand operated power tool 1 is described herein as being battery operated, the power tool 1 is not limited to this type of power supply. For example, in some embodiments, the power tool 1 may be a wired or corded power tool that is configured to be manually connected to a power mains via a plug.

Although the LED filament 60 is described herein as being secured to an outer surface of the power tool housing 2, the LED filament is not limited to this configuration. In some embodiments, the LED filament 60 is secured to an inner surface of the power tool housing 2 and is visible through a transparent or partially transparent region of the tool housing 2. In other embodiments, the LED filament is disposed inside the tool housing 2 and secured to structural or operational components of the tool at a location near a transparent or partially transparent region of the tool housing.

Selective illustrative embodiments of a power tool including LED filament illumination are described above in some detail. It should be understood that only structures considered necessary for clarifying the power tool and the LED filament have been described herein. Other conventional structures, and those of ancillary and auxiliary components of the power tool and the LED filament are assumed to be known and understood by those skilled in the art. Moreover, while working examples of the power tool and the LED filament have been described above, the power tool and the LED filament are not limited to the working examples described above, but various design alterations may be carried out without departing from the assembly as set forth in the claims.

We claim,

1. A power tool comprising:
a tool housing;
an electric motor disposed in the tool housing, the electric motor including an output shaft;
a working tool that is mechanically connected to the output shaft and protrudes from the tool housing, the working tool configured to transmit the motion of the output shaft to an accessory of the tool; and
an elongate LED filament, a portion of the LED filament being supported on a portion of the tool housing, the LED filament including a substrate and micro-LEDs disposed on the substrate in a spaced-apart, electrically connected arrangement in such a way the light is emitted from the LED filament in a direction perpendicular to the substrate over a range of angles from 0 degrees to 360 degrees.

2. The power tool of claim 1, wherein the substrate has sufficient flexibility that the LED filament can bend about each of three orthogonal axes through a radius of 5 mm.

3. The power tool of claim 1, wherein
the portion of the tool housing includes a portion of an outer surface of the tool housing having a contoured shape, and
the portion of the LED filament is arranged on the portion of the tool housing in such a way as to illuminate the contoured shape.

4. The power tool of claim 1, wherein
the portion of the tool housing includes a portion of an outer surface of the tool housing having a contoured shape, and
the portion of the LED filament is arranged on the portion of the tool housing in such a way as to trace a profile of the contoured shape.

5. The power tool of claim 1, wherein
the portion of the tool housing includes a groove,
the groove is configured to receive and retain the portion of the LED filament, and
the portion of the LED filament is disposed in the groove.

6. The power tool of claim 5, wherein
the groove is formed on an outer surface of the tool housing, and
the groove is shaped and dimensioned so that when the portion of the LED filament is disposed in the groove, the portion of the LED filament protrudes relative to the tool housing outer surface.

7. The power tool of claim 5, wherein
the groove is formed on an outer surface of the tool housing,
the groove is shaped and dimensioned so that when the portion of the LED filament is disposed in the groove, the portion of the LED filament is recessed relative to the tool housing outer surface.

8. The power tool of claim 5, wherein
when the groove is viewed in cross-section, a groove axis is defined by a line extends through a first point and a second point, where the first point is midway between sidewalls of the groove at a location corresponding to the intersection of the groove with the tool housing outer surface and the second point is midway between sidewalls of the groove at a location corresponding to a blind end of the groove, and
the groove axis is perpendicular to the portion of the tool housing.

9. The power tool of claim 5, wherein
when the groove is viewed in cross-section, a groove axis is defined by a line extends through a first point and a second point, where the first point is disposed midway between sidewalls of the groove at a location corresponding to the intersection of the groove with the tool housing outer surface and the second point is disposed midway between sidewalls of the groove at a location corresponding to a blind end of the groove, and
the groove axis is acutely angled with respect to the portion of the tool housing.

10. The power tool of claim 1, wherein the LED filament includes
an elongate, cylindrical body having a first end and a second end that is opposite the first end,
a first electrical terminal protruding from the first end, and
a second electrical terminal protruding from the second end, and wherein
the body has a diameter in a range of 1 mm to 5 mm.

11. The power tool of claim 1, wherein the LED filament includes
an elongate body having a first end and a second end that is opposite the first end, the body having a length corresponding to a distance between the first end and the second end when the body is arranged linearly,
and
the body supports at least 300 micro-LEDs per meter of body length.

12. The power tool of claim 1, wherein
the LED filament includes a flexible cylindrical substrate that supports micro-LEDs along a length of the substrate, and wherein the substrate is covered by a coating that extends along the length of the substrate and about the circumference of the substrate such that the coating is concentric with the substrate and encloses the substrate and the micro-LEDs.

13. The power tool of claim 1, the power tool being configured to connect to a power supply, and the power supply provides power to the electric motor and the LED filament.

14. The power tool of claim 1, wherein the power tool includes a structure that abuts a surface of the workpiece when the power tool is in use, the structure comprising:
a contact surface that faces and abuts the workpiece when the power tool is in use, and
an adjoining surface that adjoins the contact surface along an edge, and wherein the portion of the tool housing extends along the edge whereby the portion of the LED filament extends along the edge.

15. The power tool of claim 1, wherein the portion of the LED filament is arranged in a coil stack.

16. The power tool of claim 1, wherein the portion of the outer surface of the tool housing encircles a circumference of the tool housing, and the portion of the LED filament encircles the portion of the outer surface of the tool housing at least twice.
